(19) United States
(12) Patent Application Publication
(10) Pub. No.: US 2017/0293795 A1
(43) Pub. Date: Oct. 12, 2017

(54) MOVING DEVICE, MOVING SYSTEM, TERMINAL DEVICE AND METHOD OF CONTROLLING MOVING DEVICE

(71) Applicant: CASIO COMPUTER CO., LTD., Tokyo (JP)

(72) Inventor: Takeshi OKADA, Tokyo (JP)

(73) Assignee: CASIO COMPUTER CO., LTD., Tokyo (JP)

(21) Appl. No.: 15/469,214

(22) Filed: Mar. 24, 2017

(30) Foreign Application Priority Data
Apr. 7, 2016 (JP) 2016-076961

(51) Int. Cl. G06K 9/00; H04B 5/00; H04N 7/18; B64D 47/08; H04N 5/225; B64C 39/02; B64C 27/08; H04W 4/02; G03B 15/00

(52) U.S. Cl. CPC G06K 9/0063; H04W 4/025; H04B 5/0031; G06K 9/00288; H04N 7/183; G03B 15/006; H04N 5/2256; B64C 39/024; B64C 27/08; B64D 47/08; B64C 2201/024; B64C 2201/108; B64C 2201/127; B64C 2201/165

(57) ABSTRACT

A moving device for moving along a terminal device includes a first control unit and a second control unit. The first control unit is configured to move the moving device from a position far from the terminal device to a vicinity of the terminal device based on a current position of the terminal device. The second control unit is configured to recognize the terminal device or a user of the terminal device in the vicinity of the current position of the terminal device.

### CROSS-REFERENCE TO RELATED APPLICATION

This application is based upon and claims the benefit of priority under 35 USC 119 of Japanese Patent Application No. 2016-076961 filed on Apr. 7, 2016, the entire disclosure of which, including the description, claims, drawings, and abstract, is incorporated herein by reference in its entirety.

### BACKGROUND OF THE INVENTION

### 1. Field of the Invention

The present invention relates to a technology for controlling movement of a device for moving a moving device from afar back to a user.

### 2. Description of the Related Art

Flying cameras for performing imaging from the air such as so-called drones are spreading. Also, technologies for using an industrial product or a security product to track an object and image the object have been known.

As a prior art of flying cameras having a tracking function, the following technology has been known (for example, a technology disclosed in JP-A-2014-53821). A flying unit having a camera identifies a mark given to a worker by image recognition or the like, and flies along the mark if the worker moves, and acquires images of areas around the work. The images acquired by the flying unit are transmitted to a base apparatus, and are relayed from the base apparatus to a monitoring center in real time. Therefore, the monitoring center can recognize movement and work contents of the worker by the images. According to this configuration, even in cases where security objects move and cases where it is difficult to install permanent monitoring cameras, it is possible to flexibly acquire images of objects.

As a prior art of flying cameras having a tracking function, the following technology has also been known (for example, a technology disclosed in JP-A-2015-48025). A defense device 1 includes an umbrella unit for covering a moving object 25 from above, thereby defending the moving object against predetermined disturbances, an aerial movement mechanism for moving the umbrella unit in the air, an aerial movement drive unit thereof an activation information receiving unit, an imaging unit, and a control unit. If the activation information receiving unit receives activation information, the control unit activates the defense device, and controls the imaging unit such that the imaging unit starts imaging. After the activation, the control unit recognizes the moving object based on images acquired by the imaging unit. Also, if the control unit detects movement of the moving object based on images acquired by the imaging unit, it controls the aerial movement drive unit such that movement of the defense device in the air follows the movement of the moving object recognized by a recognizing means, thereby defending the moving object against the predetermined disturbances by the umbrella unit even when the moving object moves.

### SUMMARY OF THE INVENTION

According to one aspect of the invention, a moving device for moving along a terminal device includes a first control unit and a second control unit. The first control unit is configured to move the moving device from a position far from the terminal device to a vicinity of the terminal device based on a current position of the terminal device. The second control unit is configured to recognize the terminal device or a user of the terminal device in the vicinity of the current position of the terminal device.

According to another aspect of the invention, in a moving system, a moving device moves by communication with a terminal device. The terminal device transmits a current position of the terminal device to the moving device. The moving device includes a first processing unit which is configured to receive information on the current position of the terminal device and to move toward the current position of the terminal device. The moving device further includes a second processing unit which is configured to identify the terminal device or a user of the terminal device when the moving device is close to the current position of the terminal device based on the received information.

According to further another aspect of the invention, a terminal device performs communication with a moving device and controls the moving device such that the moving device flies to a position above an object and performs imaging on the object. The terminal device includes a terminal-side position detecting unit and a terminal-side control unit. The terminal-side position detecting unit is configured to detect a position of the terminal device. The terminal-side control unit is configured to detect a current position of the terminal device by the terminal-side position detecting unit based on a call instruction of a user, and is configured to perform a current-position-information transmitting process of transmitting information on the current position to the moving device.

According to further another aspect of the invention, a method of controlling a moving device, includes: receiving information on a current position of a terminal device and electric waves of a positioning system and controlling a position of a moving device, until the moving device reaches a vicinity of the terminal device; and after the moving device reaches the vicinity of the terminal device, identifying the terminal device or a user of the terminal device.

### BRIEF DESCRIPTION OF THE DRAWINGS

FIG. 1 is a view illustrating a configuration example of an embodiment of a flying camera system according to the present invention.

FIG. 2 is a view for explaining an operation of the flying camera system.

FIG. 3 is a block diagram illustrating a configuration example of a flying camera device.

FIG. 4 is a block diagram illustrating a configuration example of a wearable device.

FIG. 5 is a flow chart illustrating a control process example of the wearable device.

FIG. 6 is a flow chart illustrating a part of a control process example of the flying camera device.

FIG. 7 is a flow chart illustrating the other part of the control process example of the flying camera device.

FIG. 8 is a flow chart illustrating a detailed example of a returning process.

### DETAILED DESCRIPTION OF THE PREFERRED EMBODIMENTS

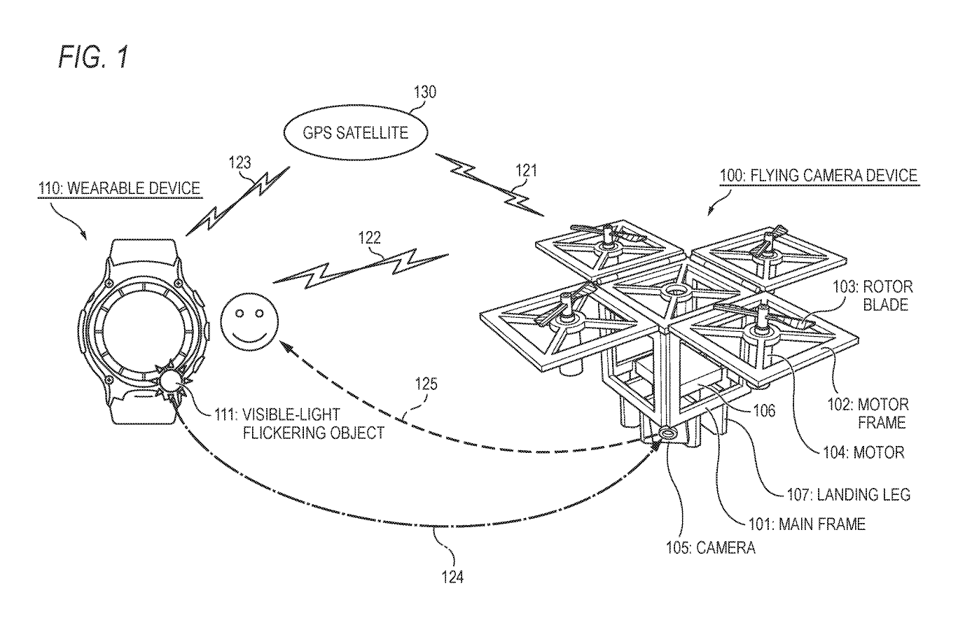

Hereinafter, a mode for carrying out the present invention will be described in detail with reference to the accompanying drawings. FIG. 1 is a view illustrating a configuration example of an embodiment obtained by applying a moving device according to the present invention to a flying camera system. The present embodiment is composed of a flying camera device 100, a wearable device 110 which is a terminal device, and a visible-light flickering object 111 which is configured integrally with or separately from the wearable device 110.

In the flying camera device 100, four motor frames 102 (supporting units) are attached to a main frame 101. The motor frames 102 are configured to be capable of supporting motors 104, and rotor blades 103 are fixed to motor shafts of the motors 104. The rotor blades 103 have a predetermined attack angle such that their rotation causes lift. The four pairs of the motors 104 and the rotor blades 103 constitute propelling units.

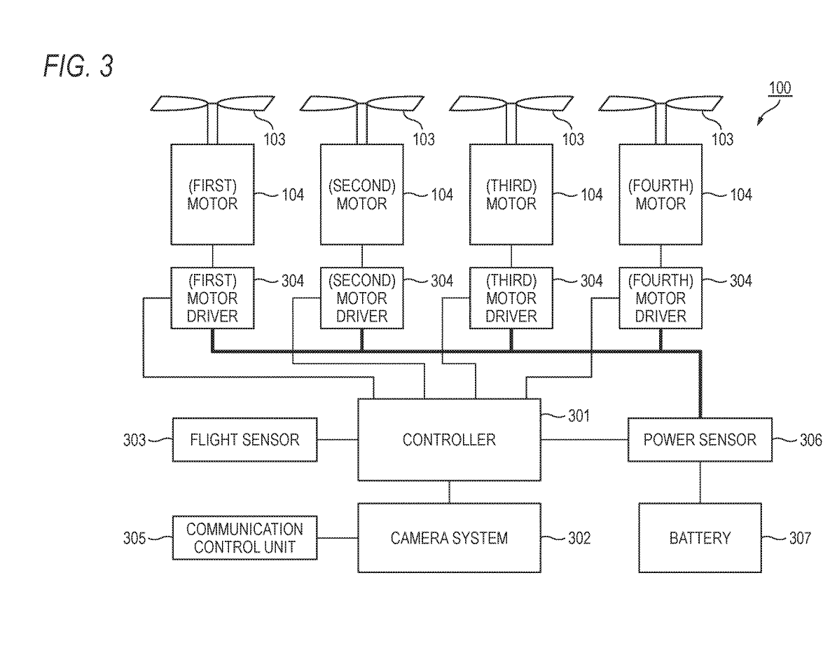

On the lower portion of the main frame 101, a camera 105 is attached as a camera unit. This camera 105 is, for example, a hemispherical camera, and can simultaneously or sequentially acquire images of areas below the flying camera device 100 in the range of 360 degrees. Around the camera 105, landing legs 107 are installed. The main frame 101 contains a control box 106 which contains various control devices to be described below with reference to FIG. 3. The flying camera device 100 includes a sensor (a camera-side position detecting unit) for receiving electric waves of a global positioning system (GPS), as one of the various control devices, such that it can receive electric waves from GPS satellites 130 as shown by a reference symbol “121” in FIG. 1, thereby capable of measuring the current position of the flying camera device on the earth. In addition to this, the flying camera device 100 may include, for example, a sensor for receiving electric waves of an indoor positioning system which is a combination of a wireless LAN (a local area network) or Bluetooth with a beacon technology, so as to be capable of measuring the current position of the flying camera device in a specific building.

As shown by a reference symbol “122” in FIG. 1, the flying camera device 100 (a camera-side communication control unit) can perform data communication with the wearable device 110 (a terminal-side communication control unit) which is a terminal device, for example, like a watch, based on a mobile telephone communication standard such as Long Term Evolution (LTE) which is a registered trademark, or a near field communication standard such as Bluetooth Low Energy (BLE) Class 1 (wherein “Bluetooth” is a registered trademark). Also, the wearable device 110 includes a sensor (a terminal-side position detecting unit) for receiving electric waves of the GPS, such that it can receive electric waves from the GPS satellites 130, thereby capable of measuring the current position of the wearable device on the earth. In addition to this, the wearable device 110 may include, for example, a sensor for receiving electric waves of the above-described indoor positioning system which is a combination of a wireless LAN (a local area network) or Bluetooth with a beacon technology, so as to be capable of measuring the current position of the flying camera device in a specific building.

The visible-light flickering object 111 (a visible-light emitting unit) is a device capable of driving, for example, a light emitting diode (LED) to flicker, and can emit visible light, for example, such that the visible light flickers. The visible-light flickering object 111 may be installed at a portion of the wearable device 110, or may be assembled on a bracelet, a brooch, or a pendant, independently from the wearable device 110.

When the flying camera device 100 is close to the current position of the wearable device 110, it can catch the flickering light emitted from the visible-light flickering object 111 close thereto, by the camera 105, as shown by a reference symbol “124” in FIG. 1, and then can recognize the face of a user having the visible-light flickering object 111.

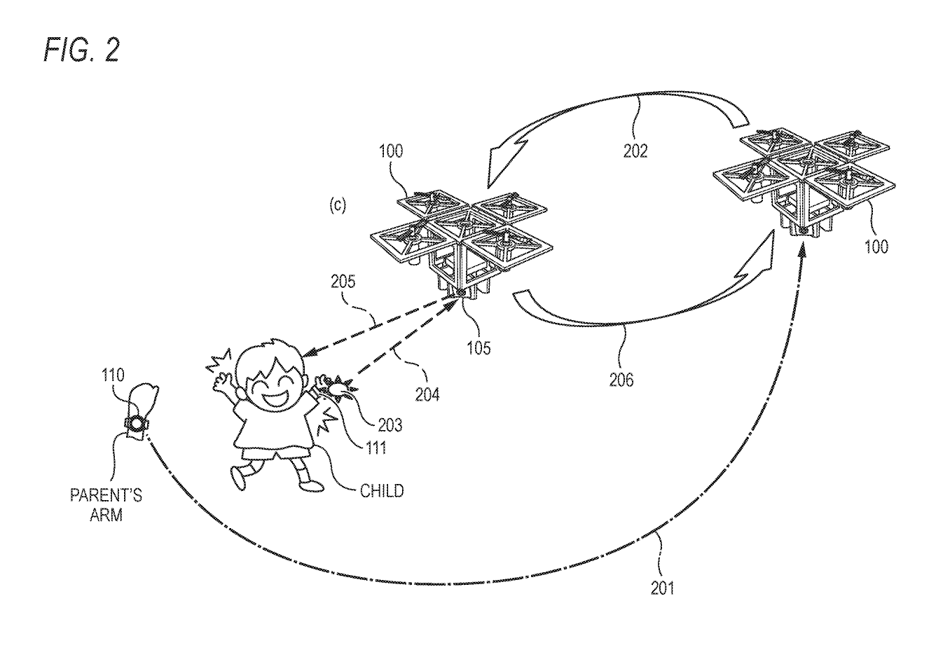

FIG. 2 is a view for explaining an operation of the flying camera system of FIG. 1. For example, a parent has the wearable device 110 on an aim, and a child has the visible-light flickering object 111 on an aim. At first, the flying camera device 100 is disposed at an arbitrary position away from the parent and the child.

In this state, if the parent performs a call instruction operation on the wearable device 110, in response to the call instruction, the wearable device 110 detects the current position of the wearable device by a GPS sensor, and performs a current-position-information transmitting process of transmitting information on the current position to the flying camera device 100 (a reference symbol “201” of FIG. 2).

If the flying camera device 100 receives the information on the current position of the wearable device 110 from the wearable device, it performs a process of controlling the propelling units including the motors 104 and the rotor blades 103 while sequentially comparing the current position of the wearable device based on the received information with current positions of the flying camera device sequentially detected by the GPS sensor such that the flying camera device flies toward the current position of the wearable device 110 (a reference symbol “202” of FIG. 2).

If the flying camera device 100 gets close to the current position of the wearable device 110 based on the received information, while searching for, for example, flickering visible light emitted by the visible-light flickering object 111 of the child close to the wearable device 110 of the parent (reference symbol “203” and “204” of FIG. 2), it performs a face recognizing process of recognizing the face of the child and an imaging process of performing imaging with a focus on the recognized face by the camera 105 (a reference symbol “205” of FIG. 2).

In this case, during flight start, the flying camera device 100 performs a process of acquiring the position of the flying camera device from the GPS sensor and storing the acquired position as a flight start position. Also, if imaging finishes, the flying camera device 100 performs a returning process of flying back to the flight start position (a reference symbol “206” of FIG. 2) by controlling the propelling units including the motors 104 and the rotor blades 103 while sequentially comparing the stored flight start position with current positions of the flying camera device sequentially detected by the GPS sensor.

As described above, in the present embodiment, in response to the call instruction from the wearable device 110 operated by the parent, the flying camera device 100 can perform a series of automatic imaging operations in which it flies to an area above the child, and automatically recognizes and images the child, and returns to the original flying camera if the imaging finishes. As another usage scene of the present embodiment, for example, when a user having the wearable device 110 including the visible-light flickering object 111 is surfing in the sea, the user can call the flying camera device 100 disposed at a coast, with the wearable device 110, such that the flying camera device performs a series of automatic imaging operations in which it flies to an area above the user, and automatically images the surfing user, and returns to the coast if the imaging finishes. As a further usage scene of the present embodiment, for example, when a user having the wearable device 110 including the visible-light flickering object 111 is fishing, if a fish is caught, the user can call the flying camera device 100 disposed at a rocky area, with the wearable device 110, such that the flying camera device performs a series of automatic imaging operations in which it flies to an area above the user, and automatically images the fishing user, and returns to the rocky area if the imaging finishes. In this case, the wearable device 110 can inform the current position of the wearable device to the flying camera device 100, for example, based on a mobile telephone communication standard, and the flying camera device 100 can fly to an area over the wearable device 110, for example, based on the GPS or the above-described beacon. Therefore, even if the flying camera device 100 is disposed at first in a place or an environment where it cannot specify a user by imaging of the camera 105, it can specify and follow the user from there.

FIG. 3 is a block diagram illustrating a configuration example of the flying camera device 100 of FIG. 1. A controller 301 is connected to a camera system 302 including the camera 105 (see FIG. 1), a flight sensor 303 composed of, for example, the GPS sensor (the camera-side position detecting unit), an acceleration sensor, a gym sensor, and the like, first to fourth motor drivers 304 which drive the first to fourth motors 105 (see FIG. 1), respectively, a communication control unit 305 (the camera-side communication control unit) for performing communication with the wearable device 110 of FIG. 1, and a power sensor 306 for supplying electric power to the individual motor drivers 304 while monitoring the voltage of a battery 307. Also, although not particularly shown, electric power of the battery 307 is also supplied to the units denoted by the reference symbols “301” to “306”. The controller 301 transmits and receives a variety of control information to and from the wearable device 110 of FIG. 1 through the communication control unit 305. The communication control unit 305 is an integrated circuit for controlling wireless communication based on, for example, the LET standard or the BLE Class 1 standard. Also, the controller 301 acquires information on the posture of the airframe of the flying camera device 100 from the flight sensor 303 in real time. Also, the controller 301 uses the power sensor 306 to transmit power instruction signals to the first to fourth motor drivers 304 while monitoring the voltage of the battery 307. The power instruction signals depend on duty ratios based on pulse width modulation of the first to fourth motor drivers, respectively. As a result, the first to fourth motor drivers 304 independently control the rotation speeds of the first to fourth motors 105, respectively. Also, the controller 301 controls the camera system 302, thereby controlling an imaging operation of the camera 105 (FIG. 1).

The controller 301, the camera system 302, the flight sensor 303, the motor drivers 304, the communication control unit 305, the power sensor 306, and the battery 307 shown in FIG. 2 are mounted in the control box 106 contained in the main frame 101 of FIG. 1.

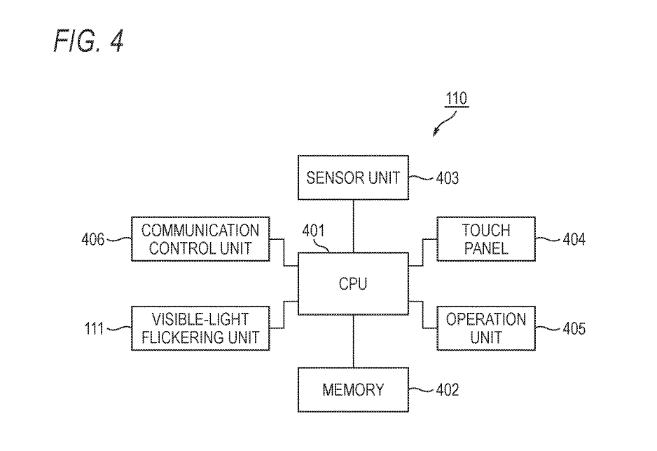

FIG. 4 is a block diagram illustrating a configuration example of the wearable device 110 of FIG. 1. The wearable device 110 includes a CPU 401, a memory 402, a sensor unit 403, a touch panel display 404, an operation unit 405, and a communication control unit 406 (the terminal-side communication control unit). The communication control unit 406 is an integrated circuit for controlling wireless communication with the communication control unit 305 included in the flying camera device 100, according to, for example, the LET standard or the BLE Class 1 standard. The memory 302 is also used as a work memory during execution of a control process program. The touch panel display 404 is a device for displaying various menus on a liquid crystal display when the user performs operations on the wearable device in order to call the flying camera device 100, and receiving user's touch input instructions. The operation unit 405 is hardware for performing various operation inputs, and is composed of, for example, operation buttons installed on the side of the case of the wearable device 110. The CPU 401 is an integrated circuit configured to control the operation of the whole wearable device 110 and including a read only memory (ROM) having the control process program stored therein. The sensor unit 403 includes at least a GPS sensor (the terminal-side position detecting unit), and may include other sensors such as an acceleration sensor.

The wearable device 110 is also connected to the visible-light flickering object 111. As described above, the visible-light flickering object 111 may be configured integrally with or separately from the wearable device 110. In a case where the wearable device 110 and the visible-light flickering object 111 are separated from each other, they may be wirelessly connected, for example, based on Bluetooth which is a wire communication standard.

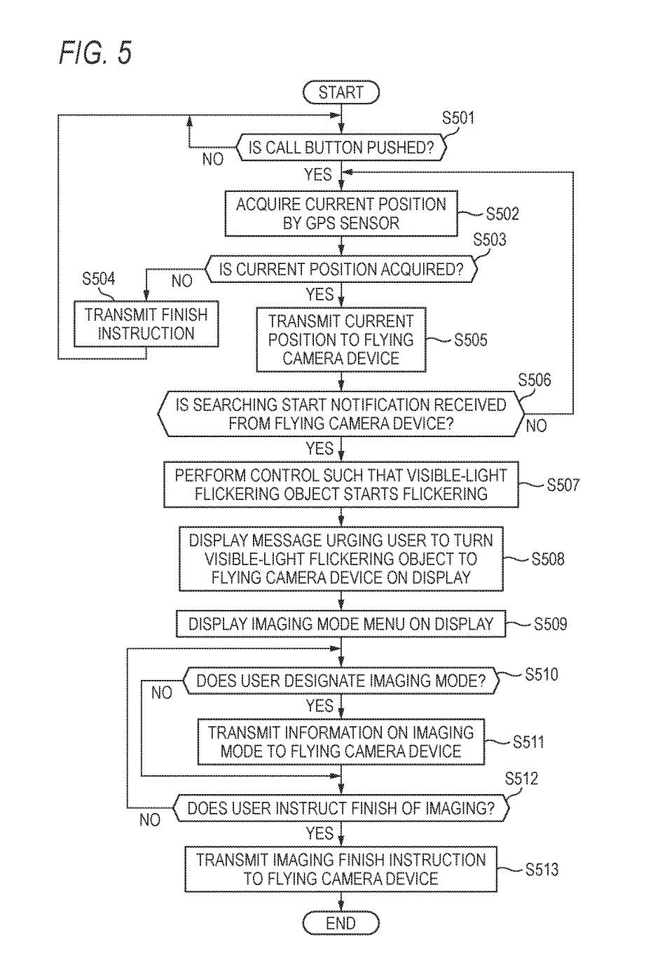

FIG. 5 is a flow chart illustrating a control process example which is performed by the CPU 401 of the wearable device 110 shown in FIG. 4. This process is an operation in which the CPU 401 executes the control process program stored in the ROM included in the CPU while using the memory 402 as a work memory. For example, if the user presses a specific operation button of the operation unit 405, the CPU 401 starts the control process.

First, the CPU 401 determines whether an operation button of the operation unit 405 (FIG. 4) has been pressed, until the determination result becomes “YES” (the determination of STEP S501 is repeated if the determination result is “NO”).

If the determination result of STEP S501 becomes “YES”, in STEP S502, the CPU 401 controls the GPS sensor included in the sensor unit 403 such that the GPS sensor acquires the current position.

In STEP S503, the CPU 401 determines whether the GPS sensor has acquired the current position.

If the determination result of STEP S503 is “YES”, in STEP S505, the CPU 401 transmits information on the current position acquired in STEP S502, to the flying camera device 100 through the communication control unit 406.

Subsequently, the CPU 401 repeatedly performs the series of the processes of STEPS S502, S503, and S505 described above (if the determination result of STEP S506 is “NO”), until it receives a searching start notification from the flying camera device 100 through the communication control unit 406.

If the CPU 401 receives a searching start notification from the flying camera device 100 through the communication control unit 406, whereby the determination result of STEP S506 becomes “YES”, in STEP S507, the CPU controls the visible-light flickering object 111 such that the visible-light flickering object starts flickering.

Subsequently, in STEP S508, the CPU 401 displays a message urging the user to turn the visible-light flickering object 111 to the flying camera device 100 flying toward the user, on the display of the touch panel display 404.

Subsequently, in STEP S509, the CPU 401 displays an imaging mode menu for allowing the user to designate an imaging mode such as a still image shooting mode, a video shooting mode, a time-lapse imaging mode, or the like.

Subsequently, in STEP S510, the CPU 401 determines whether the user has designated any one imaging mode on the touch panel display 404.

If the determination result of STEP S510 becomes “YES”, in STEP S511, the CPU 401 transmits information on the imaging mode designated by the user, to the flying camera device 100 through the communication control unit 406.

If the determination result of STEP S510 becomes “NO”, the CPU 401 skips the process of STEP S511.

Thereafter, in STEP S512, the CPU 401 determines whether the user has operated an operation button of the operation unit 405 for instructing finish of imaging.

If the determination result of STEP S512 becomes “NO”, the CPU 401 returns to the determining process of STEP S510, and repeatedly performs the series of the processes of STEPS S510 to S512.

If the determination result of STEP S512 becomes “YES”, the CPU 401 transmits the imaging finish instruction to the flying camera device 100 through the communication control unit 406. Thereafter, the CPU 401 finishes the control process shown by the flow chart of FIG. 5.

If the GPS sensor has failed to acquire the current position in the process of STEP S502, whereby the determination result of STEP S503 becomes “NO”, since the flying camera device 100 cannot grasp the current position of the wearable device 110, in STEP S504, the CPU 401 transmits a finish instruction to the flying camera device 100 through the communication control unit 406. Thereafter, the CPU 401 returns to the process of STEP S501.

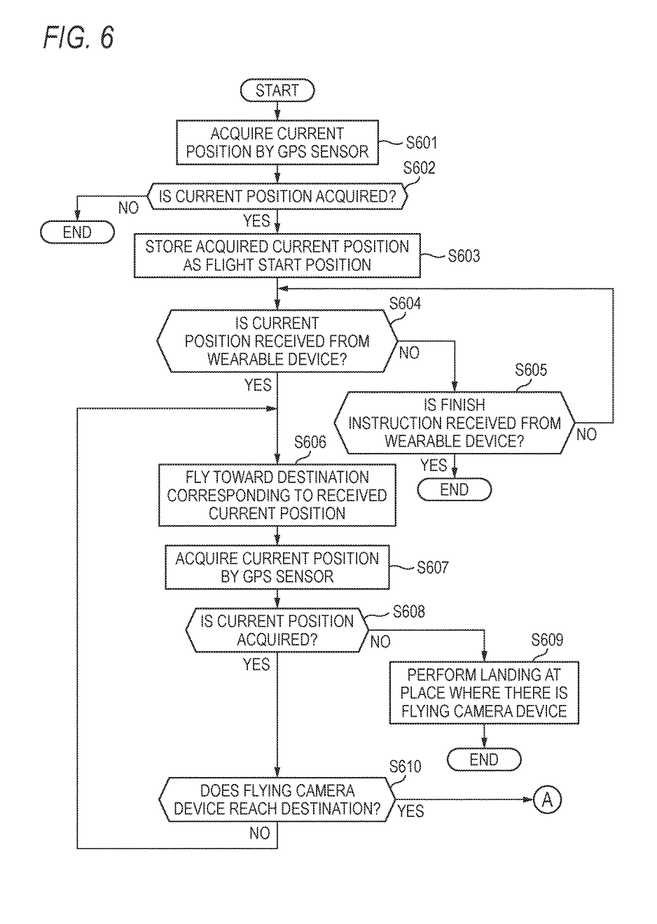

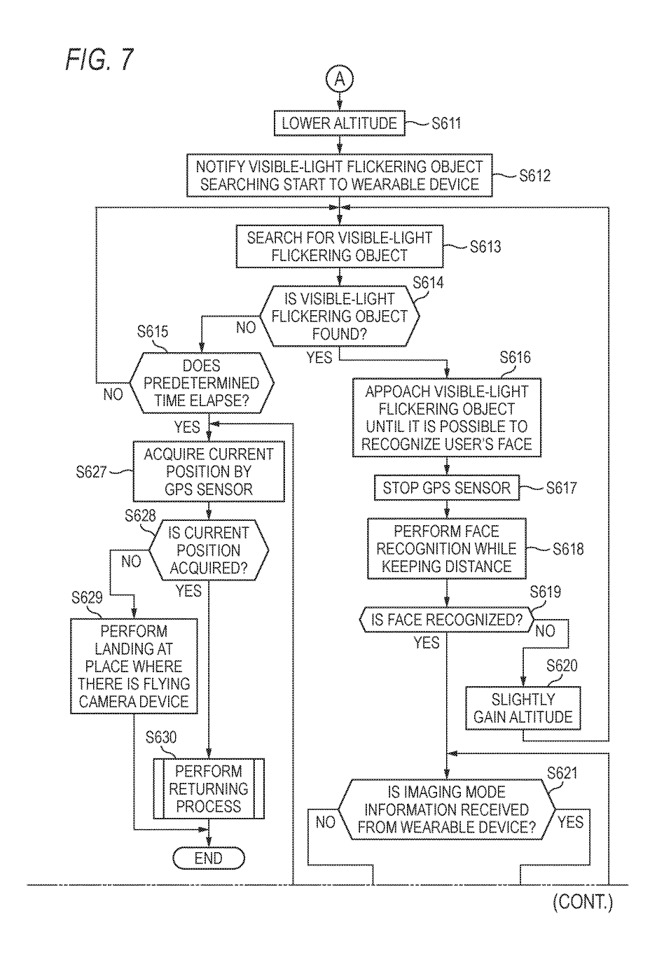

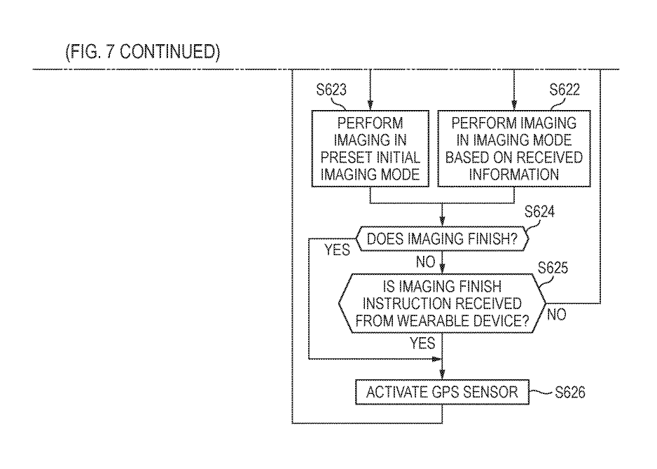

FIGS. 6 and 7 are flow charts illustrating a control process example which is performed by the controller 301 (shown in FIG. 3) of the flying camera device 100. This process is an operation in which the controller 301 executes a control process program stored in the ROM included in the controller. For example, if the user turns on a power switch (not particularly shown in the drawings), the controller 301 starts the control process.

First, in STEP S601 of FIG. 6, the controller 301 controls the GPS sensor included in the flight sensor 303 such that the GPS sensor acquires the current position.

Subsequently, in STEP S602 of FIG. 6, the controller 301 determines whether the GPS sensor has acquired the current position.

If the determination result of STEP S602 becomes “NO”, since flight is impossible, the controller 301 immediately finishes the control process shown by the flow charts of FIGS. 6 and 7.

If the determination result of STEP S602 becomes “YES”, in STEP S603 of FIG. 6, the controller 301 stores the current position acquired in STEP S601, as a flight start position, in a memory (not particularly shown in the drawings) included in the controller 301.

Subsequently, in STEP S604 of FIG. 6, the controller 301 determines whether the communication control unit 305 has received information on the current position transmitted from the CPU 401 of the wearable device 110 in STEP S505 of FIG. 5.

If the determination result of STEP S604 becomes “NO”, in STEP S605 of FIG. 6, the controller 301 determines whether the communication control unit 305 has received the finish instruction transmitted from the CPU 401 in STEP S504 of FIG. 5.

If the determination result of STEP S605 also becomes “NO”, the controller 301 returns to STEP S604.

In a case where the determination result of STEP S605 becomes “YES”, since the controller does not know the position of the wearable device 110, flight is impossible. Therefore, the controller 301 immediately finishes the control process shown by the flow charts of FIGS. 6 and 7.

If the determination result of STEP S604 becomes “YES”, in STEP S606 of FIG. 6, the controller 301 controls the first to fourth motor drivers 304 such that the flying camera device takes off and starts to fly toward a destination corresponding to the current position of the wearable device 110 based on the received information.

During the flight, the controller 301 acquires the current position by the GPS sensor included in the flight sensor 303 (STEP S607 of FIG. 6).

Then, in STEP S608 of FIG. 6, the controller 301 determines whether the GPS sensor has acquired the current position.

If the determination result of STEP S608 becomes “NO”, since the flying camera device cannot fly any more, in STEP S609 of FIG. 6, the controller 301 controls the first to fourth motor drivers 304 such that the flying camera device lands at a place where there is the flying camera device. Thereafter, the controller 301 finishes the control process shown by the flow charts of FIGS. 6 and 7.

If the determination result of STEP S608 becomes “YES”, in STEP S610 of FIG. 6, the controller 301 determines whether the flying camera device has reached the destination, by comparing the current position of the flying camera device acquired by STEP S607 with the current position of the wearable device 110 based on the information received in STEP S604.

If the determination result of STEP S610 becomes “NO”, the controller 301 proceeds to the process of STEP S606 such that the flying camera device keeps flying.

If the determination result of STEP S610 becomes “YES”, the controller 301 proceeds to the process of STEP S611 of FIG. 7. In STEP S611, the controller 301 controls the first to fourth motor drivers 304 based on the output of the flight sensor 303 of FIG. 3, such that the flying camera device lowers to such an altitude that it can search for the visible-light flickering object 111 of FIG. 1.

Subsequently, in STEP S612 of FIG. 7, the controller 301 notifies start of searching of the visible-light flickering object 111 to the wearable device 110 through the communication control unit 305.

Thereafter, in STEP S613 of FIG. 7, the controller 301 searches for the visible-light flickering object 111 by searching for flickering of the visible light emitted from the visible-light flickering object 111 while performing imaging by the hemispherical camera 105 of FIG. 1 through the camera system 302.

Then, in STEP S614 of FIG. 7, the controller 301 determines whether the visible-light flickering object 111 has been found.

If the determination result of STEP S614 becomes “NO”, in STEP S615 of FIG. 7, the controller 301 determines whether a predetermined time has elapsed from the notification of STEP S612.

If the determination result of STEP S615 becomes “NO”, the controller 301 returns to the process of STEP S613 in which the controller keeps searching for the visible-light flickering object 111.

If the determination result of STEP S615 becomes “YES”, the controller 301 performs the series of the processes of STEPS S627 to S630 of FIG. 7. These processes will be described below.

When the processes of STEPS S613 to S615 are repeatedly performed, if the visible-light flickering object 111 is found, whereby the determination result of STEP S614 becomes “YES”, in STEP S616 of FIG. 7, the controller 301 controls the first to fourth motor drivers 304 based on the output of the flight sensor 303 of FIG. 3, such that the flying camera device approaches the visible-light flickering object 111 until it becomes possible to recognize the face of the user having the visible-light flickering object 111.

Subsequently, in STEP S617 of FIG. 7, the controller 301 stops the GPS sensor included in the flight sensor 303 of FIG. 3 in order to suppress power consumption.

Subsequently, in STEP S618 of FIG. 7, the controller 301 performs a face recognizing process of recognizing the face of the user while keeping the distance from the user, by controlling the first to fourth motor drivers 304 based on the output of the flight sensor 303 of FIG. 3.

Thereafter, in STEP S619, the controller 301 determines whether the face of the user has been recognized.

If the determination result of STEP S619 becomes “NO”, in STEP S620, the controller 301 slightly gains the altitude by controlling the first to fourth motor drivers 304 based on the output of the flight sensor 303 of FIG. 3.

Thereafter, the controller 301 returns to the process of STEP S613 in which it searches for the visible-light flickering object 111 again.

If the face recognition succeeds, whereby the determination result of STEP S619 becomes “YES”, in STEP S621 of FIG. 7, the controller 301 determines whether the imaging mode information transmitted from the CPU 401 included in the wearable device 110 in the STEP S511 of FIG. 5 has been received from the communication control unit 305.

If the determination result of STEP S621 becomes “YES”, in STEP S622 of FIG. 7, the controller 301 controls the camera system 302 such that the camera system images the user by the camera 105 in the imaging mode based on the received information.

If the determination result of STEP S621 becomes “NO”, in STEP S623 of FIG. 7, the controller 301 controls the camera system 302 such that system images the user by the camera 105 in a preset initial imaging mode.

Subsequently, in STEP S624 of FIG. 7, the controller 301 determines whether the imaging set based on the imaging mode has finished.

If the determination result of STEP S624 becomes “NO”, in STEP S625 of FIG. 7, the controller 301 determines whether the imaging finish instruction transmitted from the CPU 401 included in the wearable device 110 in STEP S513 of FIG. 5 has been received.

If the determination result of STEP S625 also becomes “NO”, the controller 301 returns to the process of STEP S621 in which it controls the camera system 302 such that the camera system keeps imaging by the camera 105.

In a case where the imaging finishes, or finish of the imaging is instructed, whereby the determination result of STEP S624 or STEP S625 becomes “YES”, in STEP S626 of FIG. 7, the controller 301 activates the GPS sensor included in the flight sensor 303.

Thereafter, in STEP S627 of FIG. 7, the controller 301 acquires the current position by the GPS sensor included in the flight sensor 303.

Subsequently, in STEP S628 of FIG. 7, the controller 301 determines whether the GPS sensor has acquired the current position.

If the determination result of STEP S628 becomes “NO”, since the flying camera device cannot fly any more, in STEP S629 of FIG. 7, the controller 301 controls the first to fourth motor drivers 304 such that the flying camera device lands at a place where there is the flying camera device. Thereafter, the controller 301 finishes the control process shown by the flow charts of FIGS. 6 and 7.

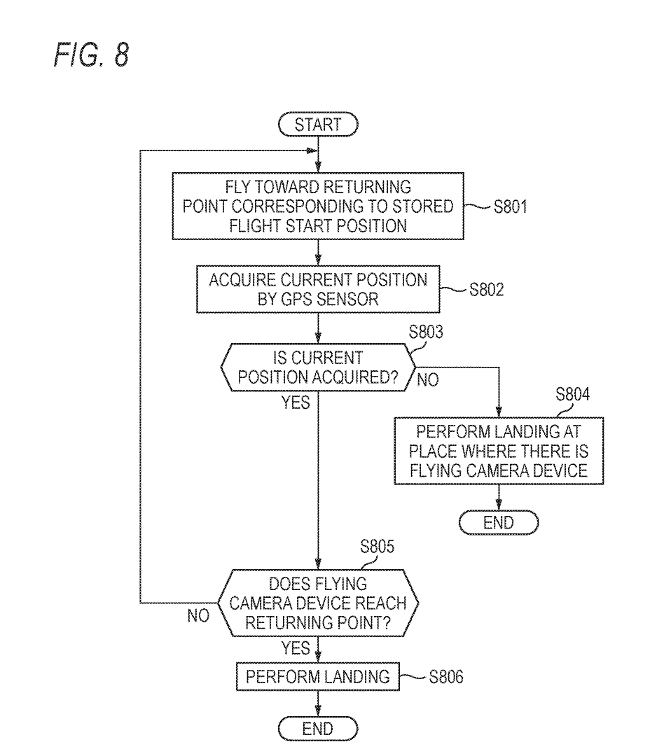

If the determination result of STEP S628 becomes “YES”, in STEP S630, the controller 301 performs a returning process. FIG. 8 is a flow chart illustrating a detailed example of the returning process of STEP S630.

First, in STEP S801, the controller 301 controls the first to fourth motor drivers 304 such that the flying camera device starts to fly toward a returning point corresponding to the flight start position stored in STEP S603 of FIG. 6.

During the flight, the controller 301 acquires the current position by the GPS sensor included in the flight sensor 303 (STEP S802).

Subsequently, in STEP S803, the controller 301 determines whether the GPS sensor has acquired the current position.

If the determination result of STEP S803 becomes “NO”, since the flying camera device cannot fly any more, in STEP S804, the controller 301 controls the first to fourth motor drivers 304 such that the flying camera device lands at the place where there is the flying camera device. Thereafter, the controller 301 finishes the process of STEP S630 of FIG. 7 shown by the flow chart of FIG. 8, thereby finishing the control process shown by the flow charts of FIGS. 6 and 7.

If the determination result of STEP S803 becomes “YES”, in STEP S805, the controller 301 determines whether the flying camera device has reached the returning point, by comparing the current position of the flying camera device acquired in STEP S802 with the flight start position stored in STEP S603 of FIG. 6.

If the determination result of STEP S805 becomes “NO”, the controller 301 proceeds to the process of STEP S801 in which it controls such that the flying camera device keeps the returning flight.

If the determination result of STEP S805 becomes “YES”, in STEP S806, the controller 301 controls the first to fourth motor drivers 304 such that the flying camera device lands at the returning point. Thereafter, the controller 301 finishes the process of STEP S630 of FIG. 7 shown by the flow chart of FIG. 8, thereby finishing the control process shown by the flow charts of FIGS. 6 and 7.

Even in a case where the visible-light flickering object 111 has not been found for the predetermined time, whereby the determination result of STEP S615 of FIG. 7 becomes “YES”, the series of the processes of STEPS S627 to S630 of FIG. 7 (including the flow chart of FIG. 8) described above is performed, whereby the flying camera device 100 returns to the returning point or lands at a place where there is the flying camera device.

According to the above-described embodiment, even if the flying camera device 100 is disposed in a place or an environment where it cannot specify the user by imaging of the camera 105, at first, it can specify and follow the user from there, and can automatically return to the flight start position if imaging finishes.

However, after imaging finishes, the flying camera device may land at a place where there is the flying camera device, or hovers in the air, based on a notification transmitted from the wearable device 110 based on a user's instruction, without returning to the flight start position.

Also, although the flying camera device has been described as an example of a moving device in the above-described embodiment, flight is not essential for movement, and the moving device may move on the ground or on water. The moving device may have a plurality of camera units. Also, the camera unit is not essential.

Although the preferred embodiment and modifications of the present invention have been described, the present invention is not limited to the specific embodiment, and inventions disclosed in claims and equivalents to those inventions are included in the present invention.

From the present invention, various embodiments and modifications can be made without departing from the broad sprit and scope of the present invention. Also, the above-described embodiment is for explaining the present invention, and does not limit the scope of the present invention. In other words, the scope of the present invention is defined by the claims, not by the embodiment. Therefore, various modifications which are made within the scope of the claims and the scope of inventions equivalent thereto are considered to fall within the scope of the present invention.

What is claimed is:

1. A moving device for moving along a terminal device, comprising:
a first control unit that is configured to move the moving device from a position far from the terminal device to a vicinity of the terminal device based on a current position of the terminal device; and
a second control unit that is configured to recognize the terminal device or a user of the terminal device in the vicinity of the current position of the terminal device.

2. The moving device according to claim 1, wherein:
the moving device is a flying device configured to fly along the terminal device,
the first control unit flies the moving device at the position far from the terminal device to the vicinity of the terminal device based on the current position of the terminal device, and
the second control unit identifies the terminal device or the user of the terminal device in the vicinity of the current position of the terminal device.

3. The moving device according to claim 1, wherein:
the first control unit includes a GPS receiving unit configured to receive electric waves from a global position system and performs position calculation, and moves the moving device to the vicinity of the current position of the terminal device while sequentially comparing the current position of the terminal device with positions of the moving device acquired by the GPS receiving unit.

4. The moving device according to claim 1, wherein:
the second control unit includes at least one of a visible-light receiving unit, a first receiving unit which is configured to receive beacon radio waves from an indoor positioning system for communication, a second receiving unit which is configured to receive data communication based on a mobile telephone communication standard, and a third receiving unit which is configured to receive data communication based on a near field communication standard.

5. The moving device according to claim 1, wherein:
the second control unit performs a face recognizing process.

6. The moving device according to claim 5, wherein:
the second control unit performs a visible-light searching process of searching for visible light emitted from a visible-light emitting device which is operates with the terminal device, and a face recognizing process of recognizing the face of the user after searching of the visible light succeeds.

7. The moving device according to claim 6, wherein:
the second control unit performs an imaging process of imaging the face with a focus on the recognized face.

8. The moving device according to claim 1, further comprising:
at least one camera unit that is configured to perform imaging;
at least one propelling unit that is configured to fly in the air;
a camera-side position detecting unit that is configured to detect the position of the moving device; and
a camera-side communication control unit that is configured to perform communication with the terminal device,
wherein the first control unit receives information on the current position of the terminal device from the terminal device through the camera-side communication control unit, and performs a process of flying the moving device to the vicinity of the current position of the terminal device based on the received information, by controlling the at least one propelling unit while sequentially comparing the current position of the terminal device based on the received information with current positions of the moving device sequentially detected by the camera-side position detecting unit.

9. A moving system in which a moving device moves by communication with a terminal device, wherein:
the terminal device transmits a current position of the terminal device to the moving device, and
the moving device includes a first processing unit which is configured to receive information on the current position of the terminal device and to move toward the current position of the terminal device, and a second processing unit which is configured to identify the terminal device or a user of the terminal device when the moving device is close to the current position of the terminal device based on the received information.

10. The moving system according to claim 9, wherein:
the terminal device further includes a visible-light emitting device which is configured to emit visible light, which is configured to be held by the user and which is configured integrally with or separately from the terminal device.

11. The moving system according to claim 10, wherein:
the moving device includes a camera-side control unit which is configured to perform a visible-light searching process of searching for visible light emitted from the visible-light emitting device when the moving device is close to the current position of the terminal device based on the received information, a face recognizing process of recognizing the face of the user after searching of the visible light succeeds, and an imaging process of controlling the camera unit such that the camera unit images the recognized face.

12. The moving system according to claim 11, wherein:
the moving device further performs a process of transmitting information representing that searching of the visible light starts, to the terminal device,
the terminal device further performs a process of controlling the visible-light emitting device such that the visible-light emitting device emits flickering visible light, when receiving the information representing that searching of the visible light starts, from the moving device, and
when the moving device detects the flickering visible light, the moving device approaches the detected flickering visible light and performs the face recognizing process.

13. The moving system according to claim 9, wherein:
the terminal device further performs a process of transmitting information on an imaging mode designated by the user, to the moving device, and
the moving device controls the camera unit such that the camera unit performs imaging in the imaging mode based on the received information.

14. The moving system according to claim 9, wherein:
the moving device further performs operations including:
a process of acquiring the position of the moving device during flight start and storing the acquired position as a flight start position; and
when the imaging finishes, a process of flying back to the flight start position while sequentially comparing the stored flight start position with current positions of the moving device sequentially detected.

15. The moving system according to claim 14, wherein:
when imaging is performed for a predetermined time or in a predetermined procedure, the camera-side control unit finishes the imaging.

16. The moving system according to claim 14, wherein:
when the user instructs finish of the imaging, the terminal-side control unit transmits an imaging finish instruction to the moving device through the terminal-side communication control unit, and
when the camera-side control unit receives the imaging finish instruction through the camera-side communication control unit, the camera-side control unit finishes the imaging.

17. A terminal device for performing communication with a moving device, thereby controlling the moving device such that the moving device flies to a position above an object and performs imaging on the object, comprising:
a terminal-side position detecting unit that is configured to detect a position of the terminal device; and
a terminal-side control unit that is configured to detect a current position of the terminal device by the terminal-side position detecting unit based on a call instruction of a user, and is configured to perform a current-position-information transmitting process of transmitting information on the current position to the moving device.

18. The terminal device according to claim 17, further comprising:
an imaging control unit that is configured to perform imaging control on the moving device.

19. A method of controlling a moving device, comprising:
receiving information on a current position of a terminal device and electric waves of a positioning system and controlling a position of a moving device, until the moving device reaches a vicinity of the terminal device; and
after the moving device reaches the vicinity of the terminal device, identifying the terminal device or a user of the terminal device.
